(19) United States
(12) Patent Application Publication
(10) Pub. No.: US 2023/0364692 A1
(43) Pub. Date: Nov. 16, 2023

(54) Clamping device for a circular saw

(71) Applicant: Festool GmbH, Wendlingen am Neckar (DE)

(72) Inventors: Luis Seifert, Karlsruhe (DE); Lukas Kleinhans, Karlsruhe (DE); Miriam Kleinschrot, Neureut (DE); Franz Schweizer, Karlsruhe (DE); Nico Höschele, Karlsruhe (DE); Stefan Seiz, Karlsruhe (DE); Thomas Gwosch, Karlsruhe (DE); Sebastian Helmstetter, Karlsruhe (DE); Sebastian Zimprich, Karlsruhe (DE); Sven Matthiesen, Karlsruhe (DE)

(21) Appl. No.: 18/310,785

(22) Filed: May 2, 2023

(30) Foreign Application Priority Data
May 10, 2022 (DE) 10 2022 111 672.7

(51) Int. Cl. B23D 47/04

(52) U.S. Cl. CPC B23D 47/04

(57) ABSTRACT

A clamping device for a circular saw includes at least one tensioning section including at least one clamping element for clamping a workpiece to the circular saw. A fastening section is provided. which is designed for fastening the clamping device to the circular saw. A receiving space sectionally receives a saw blade at its outer circumference. The fastening section includes one or more retaining sections on one or on both sides of the receiving space, which retaining sections are configured to secure the clamping device to the circular saw.

### RELATED APPLICATIONS

This application claims priority to German Patent Application Ser. No. DE 10 2022 111 672.7 filed May 10, 2022, the details of which are incorporated herein by reference.

### BACKGROUND OF THE INVENTION

### Field of the Invention

The invention relates to a clamping device for a circular saw, in particular a miter saw or a sliding compound miter saw, having at least one tensioning section, which comprises at least one clamping element for clamping a workpiece to the circular saw, wherein a clamping section is provided, which is designed for fastening the clamping device to the circular saw.

The invention further relates to a circular saw having a clamping device for clamping a workpiece.

### Description of the Prior Art

Circular saws of this type are used to cut, in particular divide, a workpiece using a saw blade. In the saw cut performed here, the saw blade is passed through the saw slot of the circular saw. In a miter saw, the saw blade is first swiveled into the saw slot and then pushed through the saw slot, cutting through the workpiece resting on a support surface of the circular saw.

In the context of this invention, a saw slot is defined in particular as the area of a circular saw into which the saw blade dips during the sawing process and/or through which the saw blade is guided during the sawing process.

To secure it during the sawing process, the workpiece is placed on a support surface of the circular saw, wherein the support surface is usually formed by a machine bed. The workpiece is oriented in the proper position on the machine bed at a stop, which is usually part of the circular saw. For safety reasons, it is additionally necessary to use a clamping device to secure the workpiece during the sawing process.

Various kinds of clamping devices are known from the state of the art. For instance, EP 2 363 233 A1 proposes a circular saw in the form of a sliding compound miter saw, in which adjustable clamping blocks are mounted at the ends of the machine bed. The clamping blocks and guides are mounted on the machine bed in such a way that they can be adjusted transversely to the saw slot. A clamping lever is assigned to each clamping block. This clamping lever can be used to secure the workpiece to the support surface of the machine bed.

Such clamping devices are suitable for clamping long workpieces that have a sufficient length transverse to the longitudinal orientation of the saw slot. Short workpieces cannot be clamped using the known device. The user has to use hands to hold the workpiece during the sawing process, which poses a significant safety risk.

DE 602 10 228 T2 (U.S. Pat. No. 6,848,350) describes solutions in which an undercut clamping slot is provided in parallel to and spaced apart from the saw slot. A workpiece can be clamped to the latter spaced apart from the saw slot. This solution does not permit cutting short workpieces either.

### SUMMARY OF THE DISCLOSURE

The invention addresses the problem of providing a clamping device of the type mentioned above, which can be used to safely and reliably clamp small workpieces, which have a small extension transverse to the longitudinal extension of the saw slot.

The invention further addresses the problem of providing a circular saw having such a clamping device.

The problem of the invention is solved in that the fastening section and/or the tensioning section form a receiving section, which is designed to sectionally receive a saw blade on its outer circumference, and in that the fastening section comprises one or more retaining section(s) on one side or on both sides of the receiving section, which retaining section(s) is/are designed and disposed to secure the clamping device in the area of a delimiting rim, preferably directly on the delimiting rim, of a saw slot of the circular saw, in a force-locked and/or form-fitting manner.

According to the invention, the receiving area of the clamping device can be disposed directly in the area of the saw slot. The clamping device is attached to or in the area of at least one support surface of one of the delimiting rims of the saw slot, preferably to or in the area of both delimiting rims. For this purpose, the retaining sections are provided for fastening, which retaining sections enable the clamping device to be secured to the circular saw in a force-locked or form-fitting manner.

During the machining operation, the outer circumference of the saw blade of the circular saw can dip into the receiving area of the clamping device to enable the separation of the workpiece using a saw cut. To this end, the tensioning sections of the clamping device hold the workpiece in the immediate vicinity of the saw slot. This makes it possible, in particular, to clamp even small workpieces, which have only a small extension transverse to the longitudinal extension of the saw slot, safely and reliably during the machining step.

For the clamping process of the workpiece, provision can be made, for instance, for the receiving area of the clamping device to be inserted into the saw slot. Then one or more guides can be used to move the clamping device along the saw slot in the direction of the workpiece until the clamping elements have sufficiently securely clamped it. The adjustment can be made in an infinitely variable manner or incrementally along the guide, wherein a constant step spacing is preferably selected for an incremental design. Preferably, for instance, the guide may be part of the retaining section.

According to a preferred embodiment of the invention, provision can be made for at least one operating element to be coupled to the clamping section of the clamping device, and for the retaining section to be movable between a locked position and an unlocked position by means of the operating element and/or for the tensioning section to be adjustable into a clamping position for clamping the workpiece. The operating element can be used to easily move the clamping section between its locked position and the unlocked position. In the unlocked position, the receiving area of the clamping element can be inserted into the saw slot. If the operating element is additionally coupled to the tensioning section, the operating element can also be used to clamp the workpiece at the same time. This results in convenient operation, which enables easy and fast clamping of the workpiece. In the opposite direction, the clamping element with the operating element can also be easily removed from the clamping slot again, for which purpose the clamping section is moved from its locked position to the unlocked position. Preferably, the operating element is equipped with a handle a user can manually grasp to achieve the desired adjustment of the clamping section or tensioning section.

A particularly preferred variant of the invention is such that the clamping section has a spring element, which can be used to move the retaining section(s) from an unlocked position to a locked position. This further simplifies the operation of the clamping device. The user only has to insert its receiving section into the saw slot. The spring element then automatically moves the retaining section(s) to the locked positioning position. If, in the process, additionally provision is made for the spring element in the locked position to introduce a preloading force to the retaining section(s) in the direction from the unlocked position to the locked position, then the spring element reliably holds the retaining section(s) in the locked position, rendering clamping the clamping device to the circular saw possible, for instance. In a variant of the invention, it is then also conceivable that additional fastening means can be dispensed with and the clamping device with the spring element is held on the circular saw without play and in a clamped manner.

For the clamping devices, a particularly simple structure results when provision is made for one transmission element each to be connected to each of the two retaining sections, for the two transmission elements to be coupled to the spring element facing away from the retaining sections, and for the transmission elements to be disposed at both sides of the receiving section.

According to a variant of the invention, provision can also be made for an actuating element to form part of a transmission mechanism by means of which the at least one retaining section and/or the at least one tensioning section can be adjusted in a range of motion. The transmission mechanism can be used to adjust the retaining section and/or the tensioning section in a power-reduced manner. In this way, the clamping device can be secured sufficiently securely to the circular saw. On the other hand, a transmission mechanism also makes for the stable support of the clamping device on the workpiece. The transmission mechanism can also be used, for instance, to establish a coupling between a manually operable operating element and the retaining section and/or the tensioning section. If the transmission mechanism is designed in such a way that both the retaining section and the tensioning section can be adjusted by the transmission mechanism, the clamping device can be operated in a particularly convenient and reliable manner. For instance, a linkage, a plane mechanism or a cam mechanism can be used as transmission mechanism. Other types of transmission mechanism are also conceivable, e.g. a gear mechanism an eccentric mechanism, etc.

According to the invention, provision can also be made for the transmission mechanism to comprise the operating element and the actuating element, wherein the operating element in the form of a lever is secured to the clamping section in a swiveling manner by means of a bearing, for the actuating element to comprises a first eccentric, which can be used to move the retaining section from the locked position to the unlocked position and vice versa, in particular to move it between the locked position to the unlocked position, and/or to move the tensioning section into the clamping position.

In addition or alternatively, provision can also be made for the actuating element to have an actuator, which can be used to move the retaining section from the unlocked position to the locked position and vice versa in order to enable an easy and safe release of the clamping devices.

If provision is made for the retaining section to be blocked in the locked position by means of a second eccentric, in particular to be secured in a form-fitting manner, then the assembly position of the clamping devices can be secured in an operationally reliable manner.

A clamping device according to the invention can also be designed in such a way that the retaining section(s) comprise(s) a support section and, spaced apart from this support section, a clamping piece, and that the support section and the clamping piece are disposed on the outside of the area facing away from the receiving section. In this variant of the invention, the support section then rests against the top face of the delimiting rim in the assembled state and/or the clamping piece rests against the underside to allow the clamping devices to be secured in place. The clamping piece or the support section then block the clamping devices transverse to the longitudinal extension of the saw slot on the circular saw.

Furthermore, it may also be the case, in particular, that the support section and/or the clamping section form a surface element, which extends in the longitudinal direction of the saw slot. This surface element can be supported on a top face or an underside adjacent to the delimiting rim. A frictional connection is then formed between the top face/underside and the surface element, for instance, which blocks or prevents any displacement of the clamping device along the saw slot in the assembled state. If the clamping device is brought into an unlocked state, the clamping device with the surface element on the top face/underside can be moved along the saw slot into the destination position.

As mentioned above, it is conceivable that the clamping piece comprises a surface element, the underside of which abuts a mating surface, which adjoins the delimiting rim. In this case, the surface element of the counterpart does not necessarily have to be flat, but provision can also be made for the surface element to form, for instance, a toothing, which meshes with a counter-toothing on the underside of the delimiting rim to enable a locking of the clamping device along the saw slot in the assembled state in a form-fitting manner. If the tooting is provided on the underside, it does not interfere with the top-end support surface for the workpiece.

Of course, provision can also be made for the delimiting edge of the boundary rim facing the saw slot to be formed to form a frictional connection and/or a form-fitting connection. For instance, the delimiting edge can be formed having a toothing that meshes with a mating toothing of the clamping device.

A particularly preferred variant of the invention is such that the tensioning section is coupled so as to be adjustable in and/or opposite to a tool clamping direction relative to the clamping section. This coupling can be used to separate the clamping function and the tensioning function from each other. This enables reliable clamping of the workpiece in the easiest possible way

Particularly preferably provision can be made for the tensioning section to be coupled to the clamping section by means of a spring section. Accordingly, the clamping device can first be clamped against the workpiece and then the clamping connection can be established. A secure hold of the workpiece is ensured via the spring section.

Additionally or alternatively, provision can also be made for a sliding guide to be coupled to the tensioning section by means of the clamping section. In this case, it is then possible, for instance, that the clamping device is first secured to the circular saw at its clamping section and then the tensioning section is clamped against the workpiece.

If provision is made for the clamping section to comprise a support section against which the tensioning section abuts in a tool clamping position with a stop, preferably with a surface section extending transversely to the workpiece clamping direction, then the cutting forces introduced into the workpiece during the machining operation can be diverted from the tensioning section into the clamping section, wherein the workpiece remains securely held in its operating position.

A clamping device according to the invention can be such that the tensioning section comprises two spaced-apart necks, which are disposed on both sides of the receiving section and which are preferably interconnected by means of a connecting element at the lower end area of the receiving section, resulting in a particularly compact arrangement.

Preferably, the tensioning section can be provided with one or more clamping elements disposed on one or both sides of the receiving section and each comprising a front workpiece clamping surface facing away from the clamping section.

Particularly secure clamping of the workpiece is achieved if the one or more workpiece clamping surface(s) is/are inclined in the direction of the workpiece clamping direction (W). The inclined workpiece clamping surface can then be designed, for instance, such that part of its clamping surface overlaps the workpiece on its end opposite from the saw slot. This can prevent the workpiece from lifting off during the machining process. Furthermore, the allocation to the workpiece can then be made in such a way that a vertical clamping force component results via the inclined workpiece clamping surface. It extends in the direction in parallel to the saw blade plane. In this way the clamping effect is strengthened.

If provision is made for at least one exchangeable clamping jaw to be disposed on the clamping element(s) of the tensioning section, wherein the clamping jaw forms the workpiece clamping surface, then the clamping device can be easily individually adapted to different workpiece geometries and workpiece orientations.

It is also conceivable for one tensioning section each to be provided on opposite sides of the clamping section in each case. The user can then choose which of the two tensioning sections to use to clamp the workpiece. In particular, the tensioning sections can have different designs and be adapted to different workpiece geometries or workpiece orientations.

As indicated above, it can be advantageous if the clamping section of the clamping device is retained in the assembly position in the longitudinal direction of the saw slot in a form-fitting manner. For this purpose, provision can also be made in particular for at least one form-fitting element to be provided on the clamping section, which form-fitting element is disposed and designed to interact with a mating form-fitting element of the circular saw to prevent displacement of the clamping section relative to the circular saw in the locked position of the clamping section opposite from the tool clamping direction, wherein provision is preferably made for a plurality of form-fitting elements and/or mating form-fitting elements to form a row of teeth.

The problem of the invention is also solved using a circular saw, in particular a miter saw or a sliding compound miter saw, having a machine bed, which has a support with a support surface for supporting a workpiece to be sawn, wherein the support has a saw slot, wherein a clamping device according to any of the claims 1 to 15 is disposed in the area of the saw slot, wherein the fastening section of the clamping device is secured in the area of the delimiting rim of the saw slot in a form-fitting and/or force-locked manner, and wherein the receiving section is disposed in the area of the saw slot.

### BRIEF DESCRIPTION OF THE DRAWINGS

The invention is described in greater detail below based on exemplary embodiments shown in the drawings. In the figure,

FIG. 1 shows a perspective view of a circular saw,

FIG. 2 shows a perspective view of a clamping device from the front,

FIG. 3 shows a perspective rear view of the clamping device of FIG. 2,

FIG. 4 shows a side view of the clamping device of FIGS. 2 and 3,

FIG. 5 shows various embodiments of a saw slot of a circular saw in cross section,

FIG. 6 shows a front view of the clamping device of FIGS. 2 to 4 in different installed positions,

FIG. 7 shows the representation of FIG. 6, wherein the clamping device is in a mounting position on the circular saw,

FIG. 8 shows a front view of a further design variant of a clamping device, wherein the clamping device is located in an installed position on the circular saw,

FIGS. 9 and 10 show a sectional view of the clamping device of FIG. 8 and various operating positions along the section marked IX-IX in FIG. 8,

FIGS. 11 to 14 show various different views and operating positions of the clamping device of FIGS. 8 to 10,

FIG. 15A shows a design variant of the clamping device of FIGS. 2 to 4,

FIGS. 15 B to 15 E show a side view of various embodiments of tensioning sections for the clamping device of FIG. 15A,

FIG. 16 shows a further design variant of a clamping device with a tensioning section disposed at an angle to the receiving section, and

FIG. 17 shows a further design variant of a clamping device having tensioning sections disposed on both sides of the receiving section.

### DETAILED DESCRIPTION

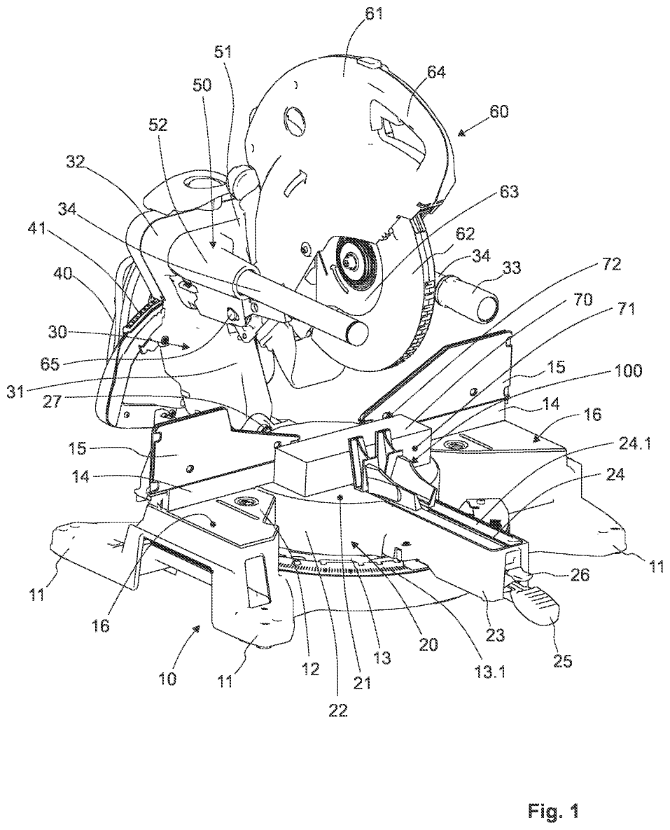

FIG. 1 shows a circular saw, in this case a sliding compound miter saw. This circular saw has a machine bed 10 whose feet 11 can be used to place it on a work surface. The machine bed 10 has a bearing part 12, which has a support section 13 for a swivel device 20. The swivel device 20 can be swiveled about a vertical swivel axis in the bearing part 12, rendering miter cuts with the circular saw possible. A scale 13.1 is also provided in the area of the support section 13, which has an angular graduation to be able to set the desired swivel position of the swivel device 20.

The machine bed 10 and the swivel device 20 form support surfaces 16 and 21 that are interaligned on a plane. Two lateral stops 14, which can be extended in the vertical direction by means of stop plates 15, are mounted on the machine bed 10.

The stops 14 are used to bring a workpiece 70 to be machined into contact, wherein the rear side 72 of the workpiece 70 can be brought into contact with the stops 14 or the stop plates 15. Opposite from the rear side 72, the workpiece 70 has a front side 71, on which a clamping device 100 acts, as will be described in more detail below.

As FIG. 1 further illustrates, the swivel device 20 has a delimiting surface 22 on the outside, which faces a mating surface of the machine bed 10 in the area of the bearing part 12. A bearing with a vertical swivel axis can be used to swivel the swivel device 20 relative to the machine bed 10.

At the front of the swivel device 20, there is a cantilever arm 23, which bears a clamped operating element 25 and a snap operating element 26 at its longitudinal end. The swivel device 20 can be swiveled about its vertical swivel axis between secured snap positions. To release the snap connection in a snap position, the swivel device 20 has to be unlocked by means of the snap operating element 26. The swivel device 20 can be swiveled in an infinitely variable manner between the snap positions. A clamp connection is used to secure the swivel device 20 in an intermediate position. The clamped operating element 25 can be used to release this clamp connection.

The circular saw has a saw slot 24, which, as in this exemplary embodiment, can extend in the area of the swivel device 20 and there, for instance, is extended into the area of the cantilever arm 23.

Delimiting rims 24.2 delimited the saw slot 24 on both sides. Support surfaces 24.1 of the delimiting rims 24.2 extend at both sides of the saw slot 24, respectively.

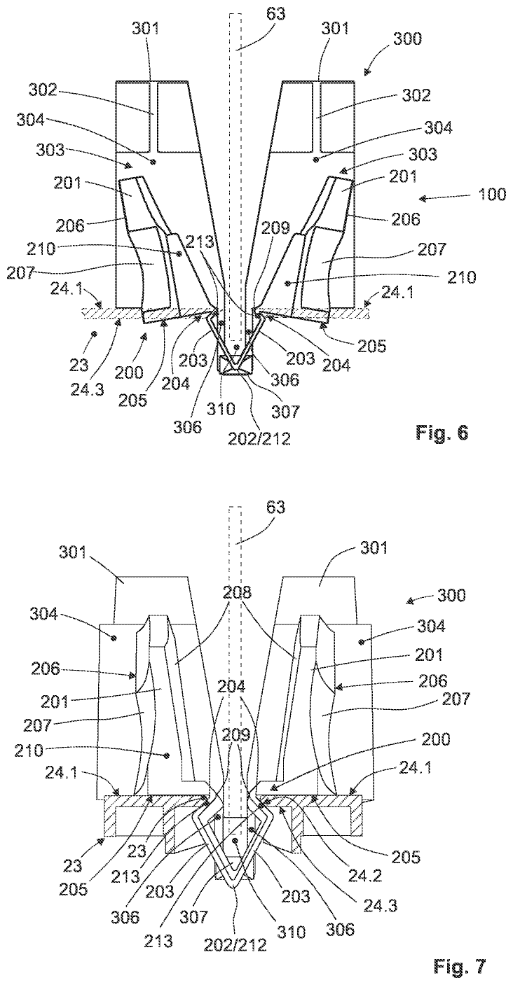

As FIGS. 6 and 7 show, provision can be made for the delimiting rims 24.2 to form an underside 24.3 on the side facing away from the support surface 24.1, which may in particular be oriented in parallel to the support surface 24.1. Towards the saw slot 24, the delimiting rim 24.2 is terminated by a delimiting edge. The delimiting edge can extend vertically relative to the support surface 24.1. However, it is also conceivable that, as FIG. 7 shows, the delimiting edge is rounded and or designed having a contour that is inclined towards the support surface 24.1.

FIG. 1 further shows that the circular saw comprises a beam 30 coupled to the machine bed 10 by a base 31 via a swivel bearing 27 having a horizontal swivel axis. The carrier 30 has a head 32 that is supported by a swivel guide on a bearing housing 40 of the machine bed 10. In the area of this support, the swiveling motion of the carrier 30 can be adjusted and secured in a guided manner relative to the bearing housing 40. A scale 41 is provided on the bearing housing 40, where the swivel position can be read. The swivel positions of the carrier 30 relative to the bearing housing 40 can, for instance, be adjusted using a coupling, in particular a transmission mechanism, a gearing, a mechanical linkage, etc. wherein the swiveled position can be achieved by means of an adjustment device 33 on the operator end.

FIG. 1 further shows that the carrier 30 has linear guide elements 34 that extend in the direction of the saw slot 24 and that guide a saw carriage 50 in that direction in a linear manner. For this purpose, the saw carriage 50 has a base body 51, on which linear bearing elements 52 are disposed, which interact with the linear guide elements 34 of the carrier 30 to form the linear guide. The adjustment device 33 is disposed at the end of one of the linear guide elements 34 in the form of a rotatable handle.

A saw device 60 is attached to the beam 30 via a cross-cut swivel bearing 65 with a horizontal swivel axis. The saw device 60 has a housing 61 having a protection cover 62. A saw blade 63 is disposed below the housing 61. In the swung-out operating position shown in FIG. 1, the underside of the saw blade 63 of the circular saw is additionally covered by a protection cover 62 of the housing 61. The housing 61 has a handle 64 with a switch. The switch can be used to activate the circular saw. At the handle 64, the saw device 60 can be swiveled relative to the support 30 about the horizontal swivel axis of the crosscut swivel bearing 65 such that the saw blade 63 can enter the saw slot 24, wherein the protective cover 62 opens to release the saw blade 63. In addition, the saw blade 63 can be adjusted along the saw slot 24 in the swiveled-in operating position. For this purpose, the saw device 60 is moved along the linear guide elements 34 of the carrier 30. A separating cut may be made in the workpiece 70.

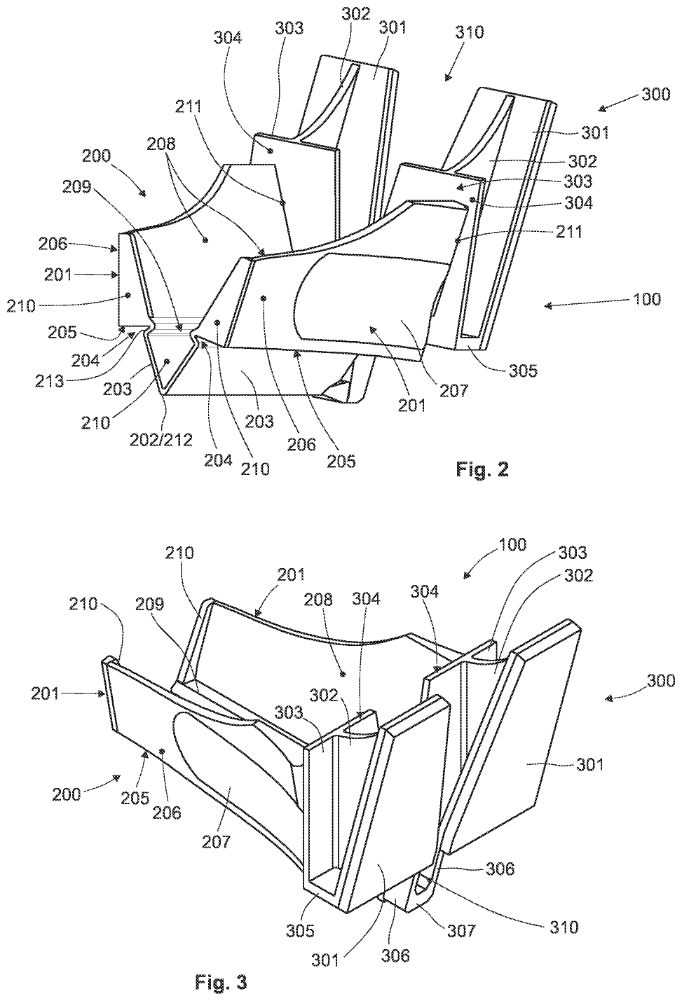

In order to securely clamp the workpiece 70 during this machining process, the clamping device 100 according to the invention is used. This clamping device 100 is explained in more detail below with reference to FIGS. 2 and 3.

As shown in these representations, the clamping device 100 has a clamping section 200 and a tensioning section 300. The clamping section 200 is also referred to herein as the fastening section 200.

The clamping section 200 has retaining sections 204 on opposite sides. These retaining sections 204 may each have a support section 205, which is formed as a surface element. Furthermore, the retaining sections 204 have clamping pieces 213, which may also be surface elements.

The support section 205 and/or the clamping piece 213 extend in the longitudinal direction of the saw slot 24. Preferably, the length of the support section 205 and/or the clamping piece 213 is at least twice that of the longitudinal extent of the width of the saw slot 24 to provide a suitable support length.

As shown in the drawings, the retaining section 204 can form a groove-shaped receptacle with the support section 205 and the clamping piece 213. The groove-shaped receptacle is designed to match the dimensions of the delimiting rim 24.2 of the saw slot 24 in such a way that the support section 205 rests on the top face of the support surface 21 of the swiveling device 20. The clamping piece 213 can then rest against the underside 24.3 and/or against the delimiting edge of the delimiting rim 24.2.

An actuating element 202 may be used to interconnect the two retaining sections 204. In particular, the actuating element 202 can be designed as a spring element 212.

In this exemplary embodiment, the retaining sections 204 are coupled to transmission elements 203, wherein the transmission elements 203 are coupled to each other in the area of the actuating element 202. Preferably, the two transmission elements 203 extend at an angle of less than 90° from each other, wherein this angle opens from the actuating element 202 towards the retaining sections 204.

Provision can also be made for one or both of the retaining sections 204 to each be coupled to an operating element 201, which is provided with an actuating element, in particular in the form of a handle 207. The handle 207 may be recessed into an outer wall 206 of the operating element 201 in the form of a recessed grip.

As FIG. 2 shows, the operating elements 201 can be coupled to the retaining sections 204, in particular to the support section 205 opposite from the transmission elements 203. The operating elements 201 can be set in a V-shape relative to each other.

In the area of the front side, the operating elements 201 each terminate with a wall piece 210, which in particular can also be integrally connected to the associated free end of the supporting section 205, as clearly shown in FIG. 2. The swivel polygon 210 braces the conveyor operating element 201 relative to the retaining section 204.

The clamping device 100 has a receiving section 310 in the area of its clamping section 200, which receiving section is designed to sectionally receive the saw blade 63 at its outer circumference when the saw blade 63 is swiveled into the area of the saw slot 24. As can be seen from the drawing, the retaining sections 204 are disposed on the outside of the clamping device on both sides of the receiving section 310. In other words, it may be the case that the receiving section 310 is delimited, at least sectionally, by the wall pieces 210 and the actuating element 202. Further, it may also be the case that the inner sides 208 of the operating elements 201 form a boundary of the receiving section 310. The receiving section 310 may also be referred to as a receiving space 310.

Facing the receiving section 310, ribs 209 are formed on opposite sides in the area of the retaining sections 204, wherein the ribs 209 extend in the longitudinal direction of the clamping device 100. The ribs 209 brace the area of the retaining sections 204.

As mentioned above, the clamping device 100 also has a tensioning section 300. This tensioning section is functionally designed to clamp the workpiece 70 to the circular saw.

There are clamping elements 301 on both sides of the receiving section 310 at the tensioning section 300. The clamping elements 301 may be configured to be integrally connected to a contact piece 303 via a connecting element 302. The abutment piece 303 may form a surface section 304 facing a support section 211 of the clamping section 200. In this regard, it may be the case that in the position of the clamping device 100 not mounted to the circular saw, the surface section 304 is spaced apart from the support section 211. Further, for rigidity reasons, provision can be made for a bar 305 to be used to connect the contact piece 303 to the clamping element 301. The support section 211 may also be referred to as a support surface 211.

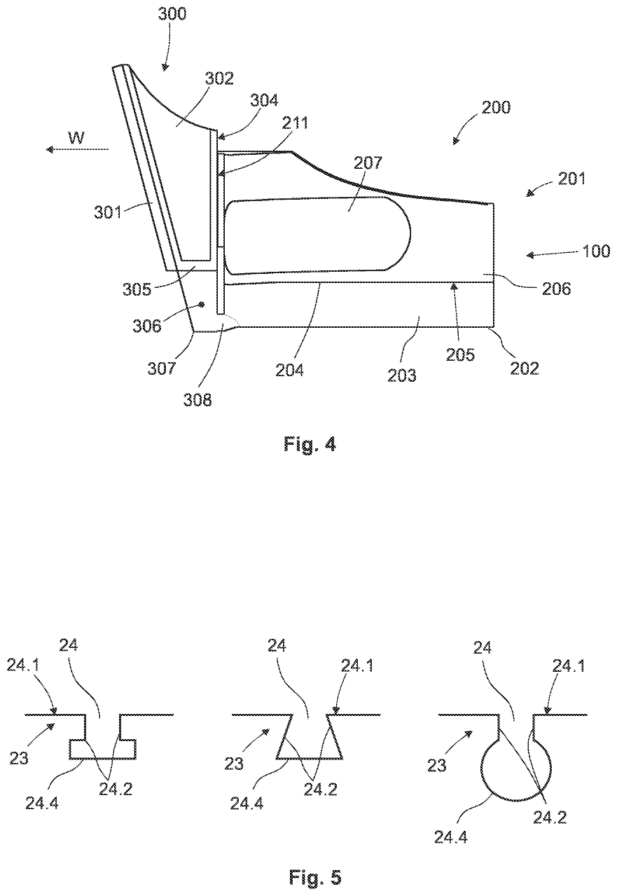

The tensioning section 300 may be coupled to the clamping section 200 via a spring section 308, which can be seen in FIG. 4. The spring action of the spring section 308 is such that the clamping elements 301 can be deflected towards the support sections 211, thereby building up a spring preload in the spring section 308. Preferably, the tensioning section 300 is integrally connected to the clamping section 200 via the spring section 308.

The clamping elements 301 are integrally interconnected by a tensioning section 307. In this regard, it may be the case that necks 306 are provided on the clamping elements 301, which necks are interconnected by the connecting element 307.

The receiving section 310 extends over both the area of the clamping section 200 and the area of the tensioning section 300, as can be seen in FIG. 3. Preferably, the receiving section 310 may be delimited by the necks 306 and the connecting element 307 in the area of the tensioning section 300.

The procedure for attaching the clamping device 100 shown in FIGS. 2 to 4 to the circular saw shown in FIG. 1 is described below with reference to FIGS. 6 and 7.

In FIG. 6, a part of the swivel device 20 with its support surface 24.1 is shown using dashed lines. Further, in this representation, the clamping device 100 is shown in front view, wherein the clamping device 100 is in its unassembled initial position. Starting from this position, the operating elements 201 on the handle pieces 207 can be swiveled towards each other. The swivel axis extends in the area of the actuating element 202. During this motion, the retaining sections 204 are moved towards each other. In particular, it may be the case that the retaining sections 204 are moved towards each other to such an extent that the maximum distance between the clamping pieces 213 is smaller than the width of the saw slot 24. Then the actuating element 202 of the clamping device 100 can be inserted headfirst into the saw slot 24. The support sections 205, which come to rest on the support surface 24.1 are used to delimit his insertion motion. Subsequently, the operating elements 201 can be relieved, wherein the actuating element 202, if it is designed as a spring element 212, then automatically moves the operating elements 201 into the position shown in FIG. 7. In this position, the support sections 205 rest on the support surfaces 24.1 of the delimiting rims 24.2 on both sides of the saw slot 24.

Depending on the design of the clamping pieces 213, they either rest against the underside 24.3 of the delimiting rims 24.2 or, as shown in FIG. 7, against the delimiting edge of the delimiting rims 24.2 facing the saw slot 24, preferably in such a way that an undercut contact results, as illustrated in FIG. 7.

The support sections 205 and the clamping pieces 213 block the displacement of the clamping device 100 in a form-fitting manner transversely to the longitudinal extension of the saw slot 24 in the assembly position shown in FIG. 7, as can be seen in FIG. 7. In the direction of the longitudinal extension of the saw slot 24, the clamping section 200 is secured on the support surface 24.1 by contact of the support section 205 and by contact of the clamping piece 213 on the delimiting rim 24.2 in a force-locked manner.

The workpiece 70 can now easily be clamped. For this purpose, only the operating elements 201 of the clamping device 100 inserted into the saw slot 24 have to be moved towards each other. Then, the entire clamping device 100 may be pushed against the workpiece 70 until the clamping elements 301 are in contact with the front face 71 of the workpiece 70.

As this has been described above, it may be the case that the surface section 304 of the clamping element 301 is spaced apart from the support section 211. When the clamping elements 301 are now pushed against the workpiece 70, the spring section 308 is deflected while a spring preload is built up. This optional embodiment provides additional spring force for improved clamping of the clamping elements 301 against the workpiece 70.

To achieve such spring preload, spring elements can also be used at any other point in the tensioning section 300. For instance, it is possible to form the clamping element 301 from a spring-elastic compressible material or to provide it with a spring-elastic layer on its clamping surface.

As FIG. 1 shows, the clamping device 100 can be used to press the workpiece 70 firmly against the stops 14. Since the clamping elements 301 are designed in such a way that they are inclined in the workpiece clamping direction W, they sectionally overlap the top face of the workpiece 70 and in that way a clamping force is exerted not only against the stops 14 but also vertically in the direction of the support surface 21.

When the workpiece 70 is clamped, the circular saw can be operated. In the process, the saw blade 63 is swiveled into the saw slot 24 and driven therethrough. In the process, the saw blade 63 enters the area of the receiving section 310 of the clamping device 100, as shown in FIG. 7. There, the saw blade 63 is shown using dashed lines. As this representation illustrates, the saw blade 63 can easily pass through the receiving section 310.

FIG. 5 shows that the invention also makes it possible to design the saw slot 24 in a functionally adapted manner in order to suitably secure the clamping device 100. At this point, it should be mentioned that the clamping device 100 according to the invention is particularly suitable for retrofitting existing and known circular saws at their respective saw slots 24. This is an advantage of the invention.

FIG. 5 shows that, in contrast to conventional solutions, the saw slot 24 can also be designed like an undercut saw slot 24. For this purpose, the saw slot 24 can have a T-shape or a dovetail shape in cross-section, as shown in FIG. 5. Furthermore, it is conceivable that a geometry of the support surface 24.1 that can be arbitrarily extended, as indicated in FIG. 5, can adjoin the delimiting rims 24.2.

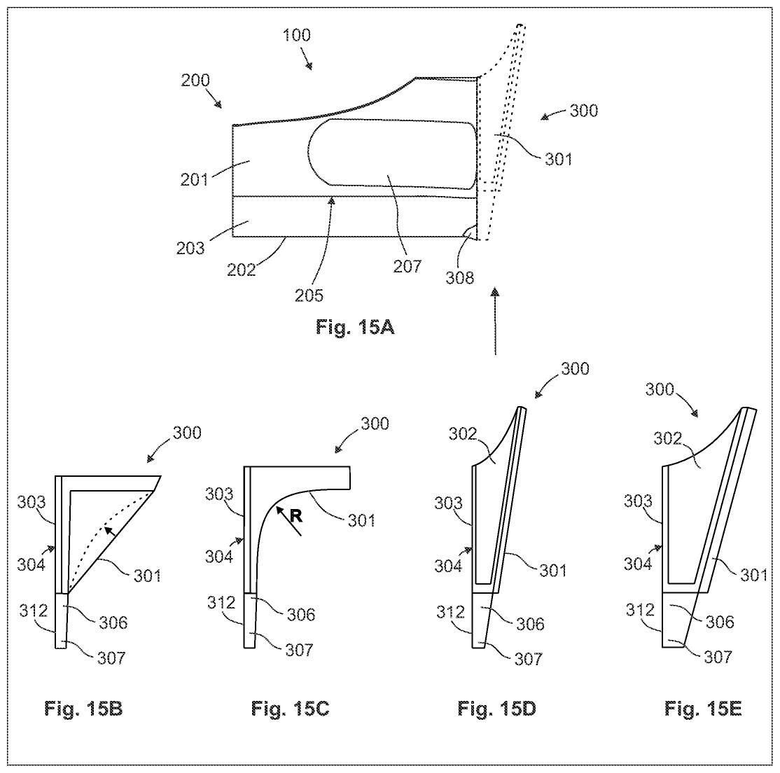

FIG. 15A shows a further design variant of the invention, which is essentially equal to the embodiment of FIGS. 1 to 7, for that reason only the differences need to be discussed below in order to avoid repetition.

As this representation shows, the clamping device 100 is configured such that the tensioning section 300 and/or the individual clamping elements 301 are interchangeably connected to the clamping section 200. This setup has the advantage that different clamping elements 301 can be used to suitably clamp differently shaped workpieces 70. It is conceivable that a suitable plug connection is provided for the exchangeable coupling of the tensioning section 300 or the clamping elements 301.

FIG. 15A shows an embodiment of a tensioning section 300 that is substantially equal to the embodiment of the tensioning section 300 shown in FIGS. 1 to 7. This tensioning section 300 is symbolically illustrated in individual representation in FIG. 15 D. The tensioning section may be replaced with a tensioning section 300 in accordance with that of FIG. 15 B, C, or F.

The tensioning section 300 shown in FIG. 15 B has a clamping element 301, which has an elastic element on its workpiece clamping surface, which elastic element is designed to conform to the contour of an irregularly shaped workpiece. A concave workpiece clamping surface is implemented in the clamping element 301 of FIG. 15 C. The tensioning section 300 of FIG. 15 E differs from that of FIG. 15 D in that the clamping element 301 is angled more strongly in the workpiece clamping direction W than the clamping element 301 of FIG. 15 D.

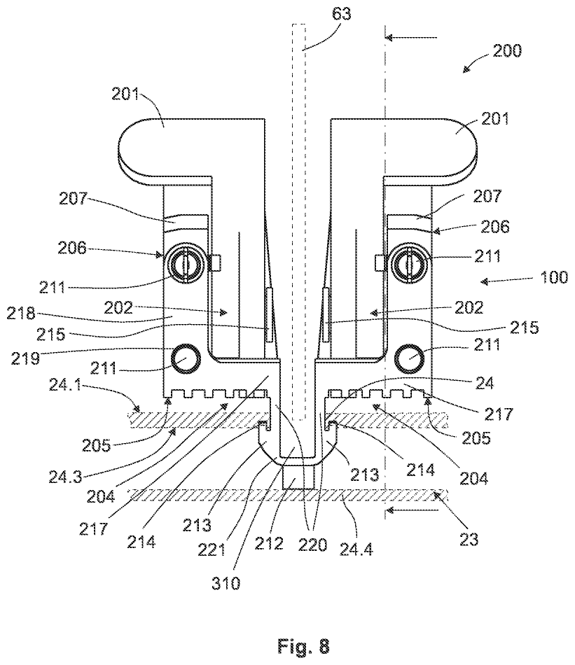

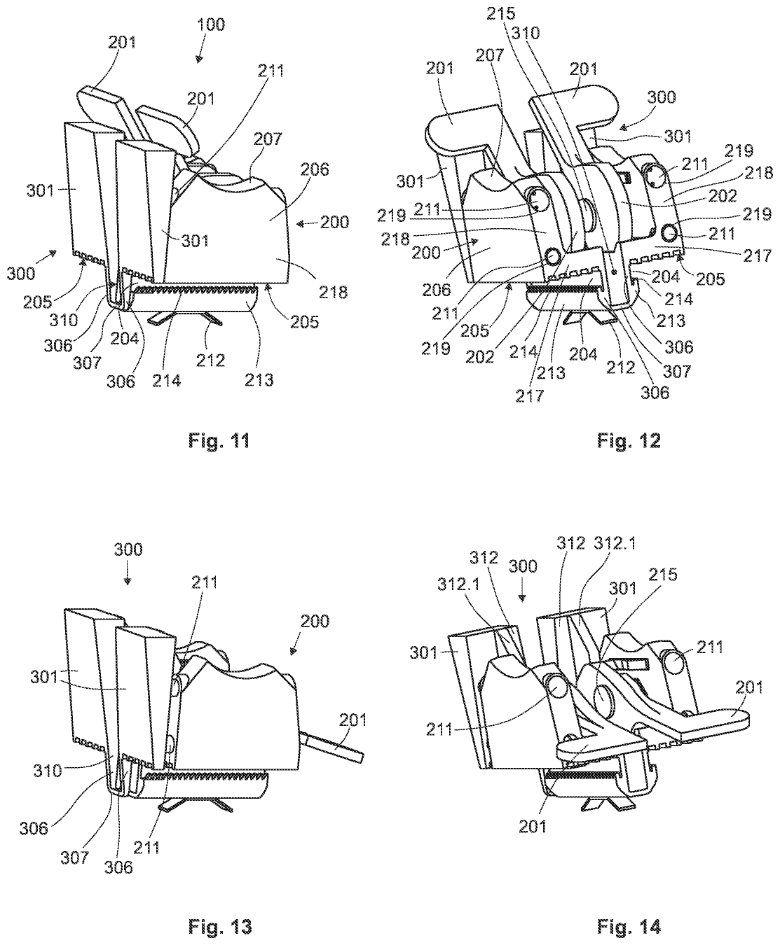

FIGS. 8 to 14 show a further design variant of embodiment of a hinge according to the invention.

As shown in these drawings, the clamping device 100 again has a clamping section 200 and a tensioning section 300. The clamping section 200 has base sections 217 on either side of the receiving section 310. The support section 205 is located at the underside of the base sections 217. Downward projecting ribs may be provided in the area of these support sections 205.

Holders 218 are attached to the base sections 217 and are spaced apart from each other. Each of the holders 218 protrudes from the top face of the base section 217. Each of the holders 218 forms a bearing mount, on which an actuating element 202 in the form of a lever is swivel mounted. For this purpose, bearings 215, for instance bearing bolts, are used, which are passed through a bearing receptacle of the actuating element 202 and inserted into the bearing receptacle of the holder 218. The swivel axes of the two actuating element 202 formed by the bearings 215 are interaligned.

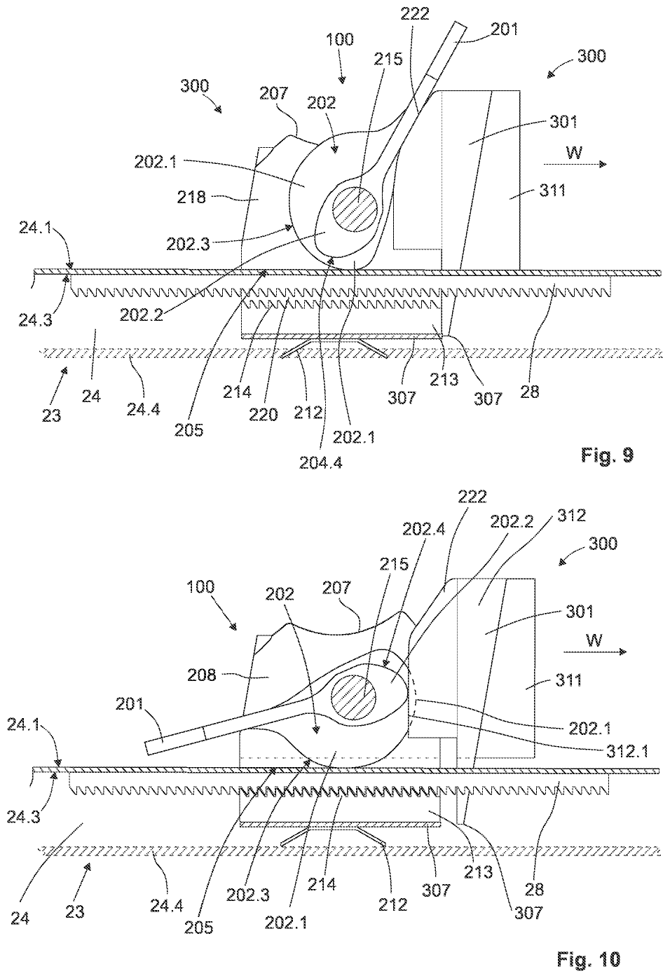

FIGS. 9 and 10 show the design of the actuating elements 202 in more detail. As shown in these representations, the actuating elements each comprise an operating element 201 spaced apart from the bearing 215, which operating element can be used to manually swivel the actuating element 202 about the swivel axis of the bearing 215. Furthermore, a first eccentric 202.1 and a second eccentric 202.2 are provided on the actuating element 202. The first eccentric 202.1 forms a guide curve 202.3, which runs on an eccentric path.

The second eccentric 202.2 has a guide cam 202.4 that runs along an eccentric path. The two eccentric paths are eccentric to the swivel axis of the bearing 215.

The drawings further show that bars 220 protrude from the base parts 217 on the underside, each forming part of a retaining section 204. Furthermore, clamping pieces 213 are formed in the area of these bars 220. The clamping pieces 213 each bear at least one form-fitting locking element 214, preferably a plurality of form-fitting locking elements 214, which may be have the form of toothings. In this case, the form-fitting elements 214 protrude towards the underside of the base parts 217. The two clamping pieces 213 may be interconnected by a connecting part 221, as shown in FIG. 8.

Several trailing edges 212 are disposed on the underside of the water connection part 221. The shape of this spring element 212 can be seen in FIGS. 9 and 10. As shown in these representations, the spring element 212 includes a fastener connected to the connection part 221. Two spring pieces protrude downward from the fastener. A receiving section 310 for the saw blade 63 is formed in the clamping section 200 between the retaining sections 204 and the connecting part 221.

FIGS. 12 and 14 show that two guides 219 are provided on each holder 218, which may have the form of linear guides, in particular in the form of drilled holes. A support section 211 in the form of a guide pin is displaceably mounted in each of these guides 219. The two support sections 211 of a holder 218 each carry a clamping element 301 at their longitudinal end. The two clamping elements 301 form part of the tensioning section 300 and may be separate from each other. It is also conceivable, as FIG. 13 shows, that the two clamping elements 301 of the tensioning section 300 are interconnected. For this purpose, a neck 306 may be formed on each clamping element 301, wherein the necks 306 are interconnected by means of a connecting element 307. To this end, the necks 306 and the connecting element 307 are disposed to continue the aforementioned receiving section 310 for the saw blade 63 in the area of the tensioning section 300.

The clamping elements 301 each have a push piece 312 on their sides facing the holders 218. This push piece 312 forms a contact surface 312.1 formed and disposed to interact with the guide cam 202.4. of the second eccentric 202.2. In this way, a cam mechanism is formed.

The clamping device 100 shown in FIGS. 8 to 10 may be mounted on a circular saw as shown in FIG. 1. In order to be able to mount this clamping device 100 on the saw slot 24 as intended, the saw slot 24 either has to be open on the front end of the cantilever arm 23 to be able to push the clamping device 100 into the saw slot 24, or it is conceivable that the saw slot 24 is widened, for instance at its end area facing the free end of the cantilever arm 23, transversely to the longitudinal extent of the saw slot 24, such that the two clamping pieces 213 of the clamping device 100 can be inserted headfirst into the cantilever arm 23 and thus into the saw slot 24.

As FIGS. 9 and 10 show, the cantilever arm 23 has a mating form-fitting element 28 at the underside 24.3 of the delimiting rim 24.2, which may be have the form of a toothed rack. The toothing of the mating form-fitting element 28 should be designed to match the toothing of the form-fitting element 214 and, in particular, have the same pitch.

Preferably, the toothings of the mating form-fitting element 28 and of the form-fitting element 214 can have a sawtooth-shaped geometry, wherein the sawtooth geometry has a steep flank against the workpiece clamping direction W and an inclined tooth flank in the workpiece clamping direction W, as FIG. 9 clearly shows.

The mating form-fitting element 28 may be located on one or both delimiting rims 24.2 of the saw slot 24.

FIG. 9 shows that the cantilever arm 23 has a bottom 24.4 that is spaced apart from the underside 24.3. The spring element 212 of the clamping device 100 rests on this bottom 24.4.

In the unlocked state of the clamping device 100, which is shown in FIG. 9, the actuating element 202 is swiveled into the unlocked position. In this unlocked position, the guide cam 202.3 of the first eccentric 202.1 rests on the support surface 24.1 of the cantilever arm 23, also forming a cam mechanism there. In particular, a part of its guide curve 202.3 of the first eccentric 202.1 rests on the support surface 24.1 of the delimiting rim 24.2, which has a long distance to the swivel axis of the bearing 215. In this operating position, the form-fitting elements 214 are out of engagement with the mating form-fitting elements 28.

The spring element 212 applies a spring preload to the clamping section 200 via the connecting part 221. This spring preload attempts to engage the clamping pieces 213 with the mating form-fitting elements 28. However, the first eccentric 202.1, which is supported on the support surface 24.1, prevents this. To maintain this operating position, the operating element 201 rests against a stop 222 of the holder 218.

If the stop 222 now lifts the operating elements 201 from the unlocked position shown in FIG. 9 and swivels them into the locked position shown in FIG. 10, the spring element 212 presses the form-fitting elements 214 upwards and brings them into engagement with the mating form-fitting elements 28 in order to achieve a form-fitting connection between the clamping pieces 213 and the delimiting rims 24.2 in the direction of the longitudinal extension of the saw slot 24. For this purpose, the guide cam 202.3 is designed in such a way that the distance of the guide cam 202.3 to the swivel axis of the bearing 215 continuously decreases when the operating elements 201 are swiveled from the unlocked position to the locked position. In this way, the tension of the spring element 212 can be continuously relieved.

The guide cam 202.4 of the second eccentric 202.2 is disposed and designed such that when the form-fitting elements 214 and the mating form-fitting element 28 begin to mesh, the second guide cam 202.4 contacts the contact surface 312.1 of the push piece 312. The second guide curve 202.4 is designed in such a way that, in the swiveling direction of the operating element 201 from the unlocked position to the locked position shown in FIG. 10, in the contact area with the contact surface 312.1 the distance of the guide curve 202.3 from the swivel axis of the bearing 215 increases continuously. This causes the clamping element 301 to be continuously displaced in the workpiece clamping direction W at the contact surface 312.1.

This positioning motion of the clamping elements 301 is guided and supported by means of the support sections 211 in the guides 219 of the holders 218.

In other words, in the clamping device 100 according to FIGS. 8 to 14, the clamping section 200 is first secured at the delimiting rims 24.2 by the two operating elements 201. Subsequently, the clamping elements 301 are adjusted in the direction of the workpiece 70 to be clamped, wherein the clamping pieces 213 are also brought into their final position at the same time.

Similar to the design variant shown in FIGS. 1 to 7, the receiving section 310 again provides an area within the saw slot 24, which the saw blade 63 can penetrate during the sawing process to cut the workpiece 70. FIG. 8 clearly shows the allocation of the saw blade 63 with the receiving section 310 during the cutting engagement.

If the clamping device 100 is to be removed again after the sawing process has been completed, or if another workpiece 70 is to be clamped, it is only necessary to swivel the operating element 201 clockwise from the initial position shown in FIG. 10 to the unlocked position shown in FIG. 9. At this point, the form-fitting elements 214 are then disengaged from the mating form-fitting element 28 and the spring element 212 is again tensioned at the bottom 24.4. The clamping device 100 can then be displaced along the saw slot 24.

FIGS. 15A to 15 E illustrate that, according to one design variant, a clamping jaw 311 can be interchangeably connected to each of the clamping elements 301 in order to individually adapt the clamping element 301 to the workpiece 70 to be clamped.

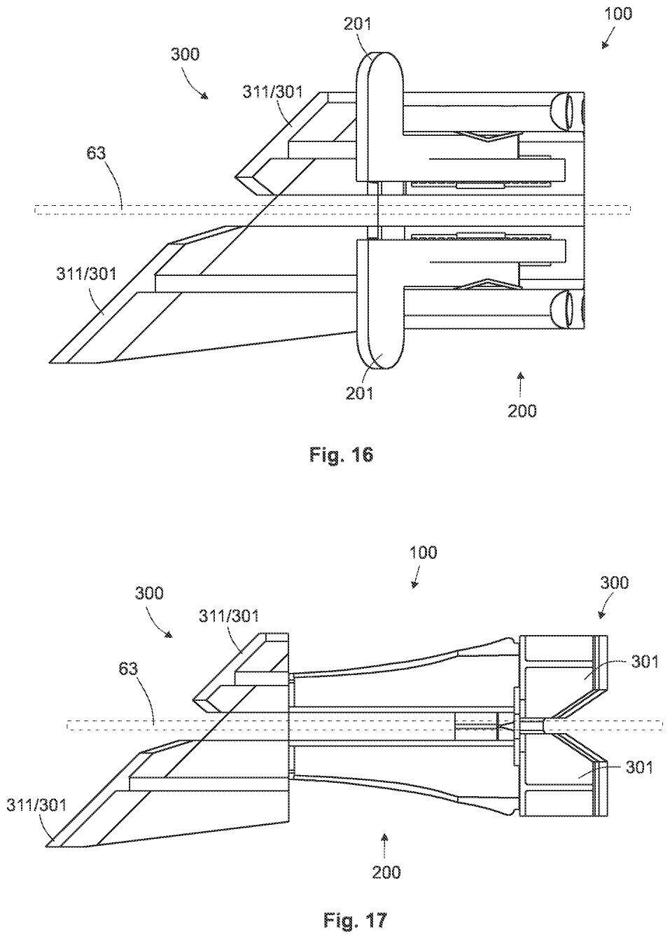

This is further specified in FIG. 16. There, it is illustrated that different or identical clamping jaws 311 may be interchangeably connected to the two clamping elements 301. However, it is also conceivable that the two clamping elements 301 are already designed differently to enable a special sawing task, for instance a miter cut.

FIG. 17 illustrates a design variant of the invention based on the embodiment of FIGS. 2 to 7. As this representation shows, two tensioning sections 300 may also be disposed on a clamping section 200.

In the embodiment used in FIG. 17, the clamping section 200 and the tensioning section 300 on the right are identical to the embodiment of FIGS. 2 to 7, i.e., reference can be made to these explanations. On the left, the additional tensioning section 300 is attached to the clamping section 200 in a similar manner as the right tensioning section 300. The left tensioning section 300 is formed to use a clamping element different from the right clamping element 301, for instance, comprising inclined clamping surfaces to execute a miter cut. For clarity, the saw blade 63 is again shown using dashed lines in this drawing.

1. A clamping device for clamping a workpiece to a circular saw, the circular saw including a saw blade having an outer circumference and the circular saw including a support surface having a saw slot defined in the support surface by a delimiting rim, the clamping device comprising:
a fastening section including one or more retaining sections configured to fasten the clamping device within the saw slot of the circular saw in a force-locked and/or form-fitting manner;
a tensioning section connected to the fastening section and including one or more workpiece clamping elements configured to clamp the workpiece;
wherein the fastening section and/or the tensioning section form a receiving space configured to receive at least a section of the outer circumference of the saw blade; and
wherein the one or more retaining sections are located on one or both sides of the receiving space.

2. The clamping device of claim 1, wherein:
the one or more retaining sections are configured to fasten the clamping device on the delimiting rim of the saw slot.

3. The clamping device of claim 1, further comprising:
at least one operating element coupled to the fastening section such that the one or more retaining sections can be moved between a locked position and an unlocked position by the operating element, the one or more workpiece clamping elements being movable into clamping engagement with the workpiece when the operating element is in the unlocked position.

4. The clamping device of claim 1, wherein:
the fastening section includes a spring configured to move the one or more retaining sections from an unlocked position to a locked position and to bias the one or more retaining sections in a direction from the unlocked position toward the locked position with a preloading force when the one or more retaining sections are in the locked position.

5. The clamping device of claim 4, wherein:
the spring and the one or more retaining sections are configured such that when the one or more retaining sections are in the unlocked position the clamping device is adjustable in a range of motion along the saw slot.

6. The clamping device of claim 4, wherein:
the one or more retaining sections includes two retaining sections; and
the fastening section includes two transmission elements connecting the two retaining sections to the spring, the two transmission elements being disposed on opposite sides of the receiving space.

7. The clamping device of claim 1, further comprising:
at least one operating element coupled to the fastening section such that the one or more retaining sections can be moved between a locked position and an unlocked position by the operating element, the one or more workpiece clamping elements being movable into clamping engagement with the workpiece when the operating element is in the unlocked position, the at least one operating element including a lever secured to the fastening section in a swiveling manner by a bearing;
a first eccentric fixed to the lever and configured to move the one or more retaining sections between the locked position and the unlocked position; and
a second eccentric fixed to the lever and configured such that the one or more retaining sections are secured in the locked position in a form-fitting manner.

8. The clamping device of claim 1, wherein:
the one or more retaining sections each include a support section and a clamping piece spaced apart from the support section, the support section and the clamping piece being disposed on an outside of the fastening section opposite from the receiving space.

9. The clamping device of claim 1, wherein:
the tensioning section is coupled to the fastening section such that the tensioning section is adjustable in and/or opposite to a workpiece clamping direction relative to the fastening section.

10. The clamping device of claim 9, wherein:
the tensioning section is coupled to the fastening section by a spring.

11. The clamping device of claim 1, wherein:
the fastening section includes a support surface;
the tensioning section includes a transverse surface extending transversely to a workpiece clamping direction; and
the support surface of the fastening section abuts the transverse surface of the tensioning section when the clamping device is in a workpiece clamping position.

12. The clamping device of claim 1, wherein:
the tensioning section includes two spaced-apart necks disposed on opposite sides of the receiving space, and a connecting element interconnecting the two spaced-apart necks at a lower end area of the receiving space.

13. The clamping device of claim 1, wherein:
the one or more workpiece clamping elements of the tensioning section includes two workpiece clamping elements disposed on opposite sides of the receiving space, each of the two workpiece clamping elements including a front workpiece clamping surface facing away from the fastening section.

14. The clamping device of claim 13, wherein:
the front workpiece clamping surface is inclined in a workpiece clamping direction.

15. The clamping device of claim 1, wherein:
the one or more workpiece clamping elements of the tensioning section each include at least one exchangeable clamping jaw forming a workpiece clamping surface.

16. The clamping device of claim 1, further comprising:
a second tensioning section connected to the fastening section on an opposite end of the fastening section from the first mentioned tensioning section.

17. The clamping device of claim 1, wherein:
the one or more retaining sections of the fastening section include at least one form-fitting element configured to interact with a mating form-fitting element of the circular saw to prevent displacement of the fastening section opposite to a workpiece clamping direction relative to the circular saw in a locked position of the fastening section.

18. The clamping device of claim 17, wherein:
the at least one form-fitting element includes a row of teeth.

19. The clamping device of claim 1 in combination with the circular saw, wherein:
the fastening section of the clamping device is secured in the saw slot and the receiving space is disposed at least in part in the saw slot.
